(19) United States
(12) Patent Application Publication
(10) Pub. No.: US 2025/0097460 A1
(43) Pub. Date: Mar. 20, 2025

(54) METHOD FOR DECODING IMMERSIVE VIDEO AND METHOD FOR ENCODING IMMERSIVE VIDEO

(71) Applicant: Electronics and Telecommunications Research Institute, Daejeon (KR)

(72) Inventors: Kwan-Jung OH, Daejeon (KR); Gwangsoon LEE, Daejeon (KR); Hong-Chang SHIN, Daejeon (KR); Jun-Young JEONG, Daejeon (KR)

(73) Assignee: Electronics and Telecommunications Research Institute, Daejeon (KR)

(21) Appl. No.: 18/884,274

(22) Filed: Sep. 13, 2024

(30) Foreign Application Priority Data
Sep. 15, 2023 (KR) 10-2023-0123380
Feb. 6, 2024 (KR) 10-2024-0018450
Sep. 12, 2024 (KR) 10-2024-0125055

(51) Int. Cl. H04N 19/597; H04N 19/46; H04N 19/59

(52) U.S. Cl. CPC H04N 19/597; H04N 19/46; H04N 19/59

(57) ABSTRACT

An image encoding method according to the present disclosure may include generating an atlas based on a plurality of viewpoint images; encoding the atlas; and encoding metadata for the atlas. In this case, the metadata may include data of a patch packed in the atlas, and the patch data may include type information of an entity corresponding to a patch.

### CROSS-REFERENCE TO RELATED APPLICATIONS

This application claims the benefit under 35 USC § 119 (a) of Korean Patent Application Nos. 10-2023-0123380 filed on Sep. 15, 2023, 10-2024-0018450 filed on Feb. 6, 2024, and 10-2024-0125055 filed on Sep. 12, 2024, in the Korean Intellectual Property Office, the entire disclosures of which are incorporated herein by reference for all purposes.

### TECHNICAL FIELD

The present disclosure relates to a method for encoding/decoding an immersive video which supports motion parallax for a rotation and translation motion.

### BACKGROUND ART

A virtual reality service is evolving in a direction of providing a service in which a sense of immersion and realism are maximized by generating an omnidirectional image in a form of an actual image or CG (Computer Graphics) and playing it on HMD, a smartphone, etc. Currently, it is known that 6 Degrees of Freedom (DoF) should be supported to play a natural and immersive omnidirectional image through HMD. For a 6DoF image, an image which is free in six directions including (1) left and right rotation, (2) top and bottom rotation, (3) left and right movement, (4) top and bottom movement, etc. should be provided through a HMD screen. But, most of the omnidirectional images based on an actual image support only rotary motion. Accordingly, a study on a field such as acquisition, reproduction technology, etc. of a 6DoF omnidirectional image is actively under way.

### DISCLOSURE

### Technical Problem

In encoding/decoding an image, the present disclosure is to provide a method for encoding/decoding information about an entity type.

In encoding/decoding an image, the present disclosure is to provide a method for embedding entity type information in an entity identifier.

The technical objects to be achieved by the present disclosure are not limited to the above-described technical objects, and other technical objects which are not described herein will be clearly understood by those skilled in the pertinent art from the following description.

### Technical Solution

An image encoding method according to the present disclosure may include generating an atlas based on a plurality of viewpoint images; encoding the atlas; and encoding metadata for the atlas. In this case, the metadata may include data of a patch packed in the atlas, and the patch data may include type information of an entity corresponding to a patch.

In an image encoding method according to the present disclosure, the metadata may further include type number information showing the number of encoded types, and lower entity information may be further encoded as much as the number of the types.

In an image encoding method according to the present disclosure, the lower entity information may indicate one of a plurality of entity type candidates, and the type information may represent a value allocated to the entity for an entity type indicated by the lower entity information.

In an image encoding method according to the present disclosure, the metadata may further include entity type information, and the entity type information may indicate the number and type of entity types to be encoded.

In an image encoding method according to the present disclosure, each of the bits configuring the entity type information may indicate whether information related to a corresponding entity type candidate should be encoded.

In an image encoding method according to the present disclosure, when a value of a bit configuring the entity type information is 1, it may represent that information related to a corresponding entity type candidate is encoded, and when a value of a bit configuring the entity type information is 0, it may represent that information related to a corresponding entity type candidate is not encoded.

In an image encoding method according to the present disclosure, the type information may be encoded by being embedded in the identification information of the entity.

In an image encoding method according to the present disclosure, the type information may be encoded separately from the identification information of the entity.

In an image encoding method according to the present disclosure, the method further includes encoding an entity map, and the entity map may be generated and encoded as many as the number of types to be encoded.

In an image encoding method according to the present disclosure, the type information may indicate at least one of whether a region including the entity is a static region or a dynamic region, whether it is a Computer Graphics (CG) region or an actual image region or whether it is a foreground or a background.

An image decoding method according to the present disclosure may include decoding an atlas; decoding metadata for the atlas; and synthesizing an image for a target viewpoint by using the decoded atlas and the decoded metadata. In this case, the metadata may include data of a patch packed in the atlas, and the patch data may include type information of an entity corresponding to a patch.

In an image decoding method according to the present disclosure, the metadata may further include type number information showing the number of decoded types, and lower entity information may be further decoded as much as the number of the types.

In an image decoding method according to the present disclosure, the lower entity information may indicate one of a plurality of entity type candidates, and the type information may represent a value allocated to the entity for an entity type indicated by the lower entity information.

In an image decoding method according to the present disclosure, the metadata may further include entity type information, and the entity type information may indicate the number and type of entity types to be decoded.

In an image decoding method according to the present disclosure, each of the bits configuring the entity type information may indicate whether information related to a corresponding entity type candidate should be decoded.

In an image decoding method according to the present disclosure, when a value of a bit configuring the entity type information is 1, it may represent that information related to a corresponding entity type candidate is decoded, and when a value of a bit configuring the entity type information is 0, it may represent that information related to a corresponding entity type candidate is not decoded.

In an image decoding method according to the present disclosure, the type information may be embedded in the identification information of the entity.

In an image decoding method according to the present disclosure, the type information may be decoded separately from the identification information of the entity.

In an image decoding method according to the present disclosure, the method further includes decoding an entity map, and the number of decoded entity maps may be the same as the number of decoded types.

According to the present disclosure, a computer readable recording medium recording a command for performing an image encoding method or an image decoding method may be provided.

In addition, according to the present disclosure, a computer readable recording medium storing a bitstream generated by an image encoding method may be provided.

The technical objects to be achieved by the present disclosure are not limited to the above-described technical objects, and other technical objects which are not described herein will be clearly understood by those skilled in the pertinent art from the following description.

### Technical Effects

According to the present disclosure, there is an effect of improving rendering quality by encoding/decoding information about an entity type.

According to the present disclosure, there is an effect of reducing the amount of data that needs to be encoded/decoded by embedding entity type information in an entity identifier.

Effects achievable by the present disclosure are not limited to the above-described effects, and other effects which are not described herein may be clearly understood by those skilled in the pertinent art from the following description.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a block diagram of an immersive video processing device according to an embodiment of the present disclosure.

FIG. 2 is a block diagram of an immersive video output device according to an embodiment of the present disclosure.

FIG. 3 is a flow chart of an immersive video processing method.

FIG. 4 is a flow chart of an atlas encoding process.

FIG. 5 is a flow chart of an immersive video output method.

FIG. 6A, FIG. 6B, and FIG. 6C illustrate an entity map.

FIG. 7 represents the definition of each bit that configures entity type information.

FIG. 8 represents an example in which a value of entity_id, an identifier allocated to an entity, is determined according to an entity type.

FIG. 9 is a diagram illustrating a problem related to basic view selection.

FIG. 10A and FIG. 10B illustrate an area where main entities are considered.

### DETAILED DESCRIPTION OF DISCLOSURE

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

An immersive video, when a user's viewing position is changed, refers to a video that a viewport image may be also dynamically changed. In order to implement an immersive video, a plurality of input images are required. Each of a plurality of input images may be referred to as a source image or a view image. A different view index may be assigned to each view image. An immersive image may be composed of images each of which has different view, thus, the immersive video can also be referred to as multi-view image.

An immersive video may be classified into 3DoF (Degree of Freedom), 3DoF+, Windowed-6DoF or 6DoF type, etc. A 3DoF-based immersive video may be implemented by using only a texture image. On the other hand, in order to render an immersive video including depth information such as 3DoF+ or 6DoF, etc., a depth image (or, a depth map) as well as a texture image is also required.

It is assumed that embodiments described below are for immersive video processing including depth information such as 3DoF+ and/or 6DoF, etc. In addition, it is assumed that a view image is configured with a texture image and a depth image.

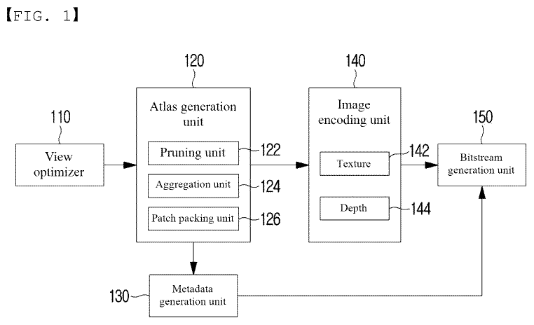

FIG. 1 is a block diagram of an immersive video processing device according to an embodiment of the present disclosure.

In reference to FIG. 1, an immersive video processing device according to the present disclosure may include a view optimizer 110, an atlas generation unit 120, a metadata generation unit 130, an image encoding unit 140 and a bitstream generation unit 150.

An immersive video processing device receives a plurality of pairs of images, a camera intrinsic parameters and a camera extrinsic parameter as an input data to encode an immersive video. Here, a plurality of pairs of images include a texture image (Attribute component) and a depth image (Geometry component). Each pair may have a different view. Accordingly, a pair of input images may be referred to as a view image. Each of view images may be divided by an index. In this case, an index assigned to each view image may be referred to as a view or a view index.

A camera intrinsic parameters includes a focal distance, a position of a principal point, etc. and a camera extrinsic parameters includes translations, rotations, etc. of a camera. A camera intrinsic parameters and a camera extrinsic parameters may be treated as a camera parameter or a view parameter.

A view optimizer 110 partitions view images into a plurality of groups. As view images are partitioned into a plurality of groups, independent encoding processing per each group may be performed. In an example, view images captured by N spatially consecutive cameras may be classified into one group. Thereby, view images that depth information is relatively coherent may be put in one group and accordingly, rendering quality may be improved.

In addition, by removing dependence of information between groups, a spatial random access service which performs rendering by selectively bringing only information in a region that a user is watching may be made available.

Whether view images will be partitioned into a plurality of groups may be optional.

In addition, a view optimizer 110 may classify view images into a basic image and an additional image. A basic image represents an image which is not pruned as a view image with a highest pruning priority and an additional image represents a view image with a pruning priority lower than a basic image.

A view optimizer 110 may determine at least one of view images as a basic image. A view image which is not selected as a basic image may be classified as an additional image.

A view optimizer 110 may determine a basic image by considering a view position of a view image. In an example, a view image whose view position is the center among a plurality of view images may be selected as a basic image.

Alternatively, a view optimizer 110 may select a basic image based on camera parameters. Specifically, a view optimizer 110 may select a basic image based on at least one of a camera index, a priority between cameras, a position of a camera or whether it is a camera in a region of interest.

In an example, at least one of a view image with a smallest camera index, a view image with a largest camera index, a view image with the same camera index as a predefined value, a view image captured by a camera with a highest priority, a view image captured by a camera with a lowest priority, a view image captured by a camera at a predefined position (e.g., a central position) or a view image captured by a camera in a region of interest may be determined as a basic image.

Alternatively, a view optimizer 110 may determine a basic image based on quality of view images. In an example, a view image with highest quality among view images may be determined as a basic image.

Alternatively, a view optimizer 110 may determine a basic image by considering an overlapping data rate of other view images after inspecting a degree of data redundancy between view images. In an example, a view image with a highest overlapping data rate with other view images or a view image with a lowest overlapping data rate with other view images may be determined as a basic image.

A plurality of view images may be also configured as a basic image.

An Atlas generation unit 120 performs pruning and generates a pruning mask. And, it extracts a patch by using a pruning mask and generates an atlas by combining a basic image and/or an extracted patch. When view images are partitioned into a plurality of groups, the process may be performed independently per each group.

A generated atlas may be composed of a texture atlas and a depth atlas. A texture atlas represents a basic texture image and/or an image that texture patches are combined and a depth atlas represents a basic depth image and/or an image that depth patches are combined.

An atlas generation unit 120 may include a pruning unit 122, an aggregation unit 124 and a patch packing unit 126.

A pruning unit 122 performs pruning for an additional image based on a pruning priority. Specifically, pruning for an additional image may be performed by using a reference image with a higher pruning priority than an additional image.

A reference image includes a basic image. In addition, according to a pruning priority of an additional image, a reference image may further include other additional image.

Whether an additional image may be used as a reference image may be selectively determined. In an example, when an additional image is configured not to be used as a reference image, only a basic image may be configured as a reference image.

On the other hand, when an additional image is configured to be used as a reference image, a basic image and other additional image with a higher pruning priority than an additional image may be configured as a reference image.

Through a pruning process, redundant data between an additional image and a reference image may be removed. Specifically, through a warping process based on a depth image, data overlapped with a reference image may be removed in an additional image. In an example, when a depth value between an additional image and a reference image is compared and that difference is equal to or less than a threshold value, it may be determined that a corresponding pixel is redundant data.

As a result of pruning, a pruning mask including information on whether each pixel in an additional image is valid or invalid may be generated. A pruning mask may be a binary image which represents whether each pixel in an additional image is valid or invalid. In an example, in a pruning mask, a pixel determined as overlapping data with a reference image may have a value of 0 and a pixel determined as non-overlapping data with a reference image may have a value of 1.

While a non-overlapping region may have a non-square shape, a patch is limited to a square shape. Accordingly, a patch may include an invalid region as well as a valid region. Here, a valid region refers to a region composed of non-overlapping pixels between an additional image and a reference image. In other words, a valid region represents a region that includes data which is included in an additional image, but is not included in a reference image. An invalid region refers to a region composed of overlapping pixels between an additional image and a reference image. A pixel/data included by a valid region may be referred to as a valid pixel/valid data and a pixel/data included by an invalid region may be referred to as an invalid pixel/invalid data.

An aggregation unit 124 combines a pruning mask generated in a frame unit in an intra-period unit.

In addition, an aggregation unit 124 may extract a patch from a combined pruning mask image through a clustering process. Specifically, a square region including valid data in a combined pruning mask image may be extracted as a patch. Regardless of a shape of a valid region, a patch is extracted in a square shape, so a patch extracted from a square valid region may include invalid data as well as valid data.

In this case, an aggregation unit 124 may repartition a L-shaped or C-shaped patch which reduces encoding efficiency. Here, a L-shaped patch represents that distribution of a valid region is L-shaped and a C-shaped patch represents that distribution of a valid region is C-shaped.

When distribution of a valid region is L-shaped or C-shaped, a region occupied by an invalid region in a patch is relatively large. Accordingly, a L-shaped or C-shaped patch may be partitioned into a plurality of patches to improve encoding efficiency.

For an unpruned view image, a whole view image may be treated as one patch. Specifically, a whole 2D image which develops an unpruned view image in a predetermined projection format may be treated as one patch. A projection format may include at least one of an Equirectangular Projection Format (ERP), a Cube-map or a Perspective Projection Format.

Here, an unpruned view image refers to a basic image with a highest pruning priority. Alternatively, an additional image that there is no overlapping data with a reference image and a basic image may be defined as an unpruned view image. Alternatively, regardless of whether there is overlapping data with a reference image, an additional image arbitrarily excluded from a pruning target may be also defined as an unpruned view image. In other words, even an additional image that there is data overlapping with a reference image may be defined as an unpruned view image.

A packing unit 126 packs a patch in a rectangle image. In patch packing, deformation such as size transform, rotation, or flip, etc. of a patch may be accompanied. An image that patches are packed may be defined as an atlas.

Specifically, a packing unit 126 may generate a texture atlas by packing a basic texture image and/or texture patches and may generate a depth atlas by packing a basic depth image and/or depth patches.

For a basic image, a whole basic image may be treated as one patch. In other words, a basic image may be packed in an atlas as it is. When a whole image is treated as one patch, a corresponding patch may be referred to as a complete image (complete view) or a complete patch.

The number of atlases generated by an atlas generation unit 120 may be determined based on at least one of an arrangement structure of a camera rig, accuracy of a depth map or the number of view images.

A metadata generation unit 130 generates metadata for image synthesis. Metadata may include at least one of camera-related data, pruning-related data, atlas-related data or patch-related data.

Pruning-related data includes information for determining a pruning priority between view images. In an example, at least one of a flag representing whether a view image is a root node or a flag representing whether a view image is a leaf node may be encoded. A root node represents a view image with a highest pruning priority (i.e., a basic image) and a leaf node represents a view image with a lowest pruning priority.

When a view image is not a root node, a parent node index may be additionally encoded. A parent node index may represent an image index of a view image, a parent node.

Alternatively, when a view image is not a leaf node, a child node index may be additionally encoded. A child node index may represent an image index of a view image, a child node.

Atlas-related data may include at least one of size information of an atlas, number information of an atlas, priority information between atlases or a flag representing whether an atlas includes a complete image. A size of an atlas may include at least one of size information of a texture atlas and size information of a depth atlas. In this case, a flag representing whether a size of a depth atlas is the same as that of a texture atlas may be additionally encoded. When a size of a depth atlas is different from that of a texture atlas, reduction ratio information of a depth atlas (e.g., scaling-related information) may be additionally encoded. Atlas-related information may be included in a “View parameters list” item in a bitstream.

In an example, geometry_scale_enabled_flag, a syntax representing whether it is allowed to reduce a depth atlas, may be encoded/decoded. When a value of a syntax geometry_scale_enabled_flag is 0, it represents that it is not allowed to reduce a depth atlas. In this case, a depth atlas has the same size as a texture atlas.

When a value of a syntax geometry_scale_enabled_flag is 1, it represents that it is allowed to reduce a depth atlas. In this case, information for determining a reduction ratio of a depth atlas may be additionally encoded/decoded. In an example, geometry_scaling_factor_x, a syntax representing a horizontal directional reduction ratio of a depth atlas, and geometry_scaling_factor_y, a syntax representing a vertical directional reduction ratio of a depth atlas, may be additionally encoded/decoded.

An immersive video output device may restore a reduced depth atlas to its original size after decoding information on a reduction ratio of a depth atlas.

Patch-related data includes information for specifying a position and/or a size of a patch in an atlas image, a view image to which a patch belongs and a position and/or a size of a patch in a view image. In an example, at least one of position information representing a position of a patch in an atlas image or size information representing a size of a patch in an atlas image may be encoded. In addition, a source index for identifying a view image from which a patch is derived may be encoded. A source index represents an index of a view image, an original source of a patch. In addition, position information representing a position corresponding to a patch in a view image or position information representing a size corresponding to a patch in a view image may be encoded. Patch-related information may be included in an “Atlas data” item in a bitstream.

An image encoding unit 140 encodes an atlas. When view images are classified into a plurality of groups, an atlas may be generated per group. Accordingly, image encoding may be performed independently per group.

An image encoding unit 140 may include a texture image encoding unit 142 encoding a texture atlas and a depth image encoding unit 144 encoding a depth atlas.

A bitstream generation unit 150 generates a bitstream based on encoded image data and metadata. A generated bitstream may be transmitted to an immersive video output device.

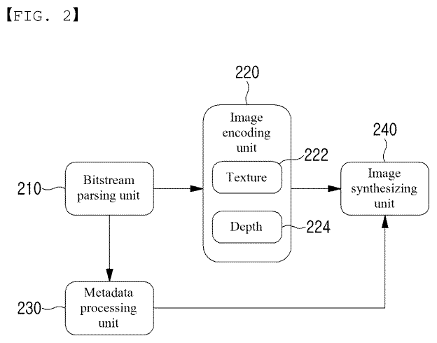

FIG. 2 is a block diagram of an immersive video output device according to an embodiment of the present disclosure.

In reference to FIG. 2, an immersive video output device according to the present disclosure may include a bitstream parsing unit 210, an image decoding unit 220, a metadata processing unit 230 and an image synthesizing unit 240.

A bitstream parsing unit 210 parses image data and metadata from a bitstream. Image data may include data of an encoded atlas. When a spatial random access service is supported, only a partial bitstream including a watching position of a user may be received.

An image decoding unit 220 decodes parsed image data. An image decoding unit 220 may include a texture image decoding unit 222 for decoding a texture atlas and a depth image decoding unit 224 for decoding a depth atlas.

A metadata processing unit 230 unformats parsed metadata.

Unformatted metadata may be used to synthesize a specific view image. In an example, when motion information of a user is input to an immersive video output device, a metadata processing unit 230 may determine an atlas necessary for image synthesis and patches necessary for image synthesis and/or a position/a size of the patches in an atlas and others to reproduce a viewport image according to a user's motion.

An image synthesizing unit 240 may dynamically synthesize a viewport image according to a user's motion. Specifically, an image synthesizing unit 240 may extract patches required to synthesize a viewport image from an atlas by using information determined in a metadata processing unit 230 according to a user's motion. Specifically, a viewport image may be generated by extracting patches extracted from an atlas including information of a view image required to synthesize a viewport image and the view image in the atlas and synthesizing extracted patches.

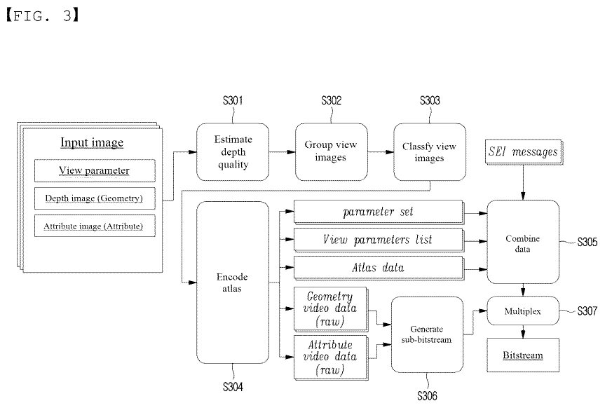

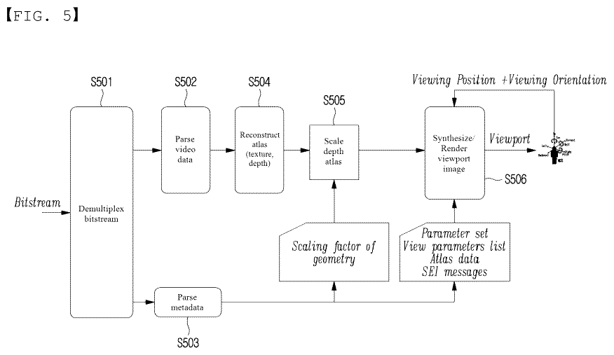

FIGS. 3 and 5 show a flow chart of an immersive video processing method and an immersive video output method, respectively.

In the following flow charts, what is italicized or underlined represents input or output data for performing each step. In addition, in the following flow charts, an arrow represents processing order of each step. In this case, steps without an arrow indicate that temporal order between corresponding steps is not determined or that corresponding steps may be processed in parallel. In addition, it is also possible to process or output an immersive video in order different from that shown in the following flow charts.

An immersive video processing device may receive at least one of a plurality of input images, a camera internal variable and a camera external variable and evaluate depth map quality through input data S301. Here, an input image may be configured with a pair of a texture image (Attribute component) and a depth image (Geometry component).

An immersive video processing device may classify input images into a plurality of groups based on positional proximity of a plurality of cameras S302. By classifying input images into a plurality of groups, pruning and encoding may be performed independently between adjacent cameras whose depth value is relatively coherent. In addition, through the process, a spatial random access service that rendering is performed by using only information of a region a user is watching may be enabled.

But, the above-described S301 and S302 are just an optional procedure and this process is not necessarily performed.

When input images are classified into a plurality of groups, procedures which will be described below may be performed independently per group.

An immersive video processing device may determine a pruning priority of view images S303. Specifically, view images may be classified into a basic image and an additional image and a pruning priority between additional images may be configured.

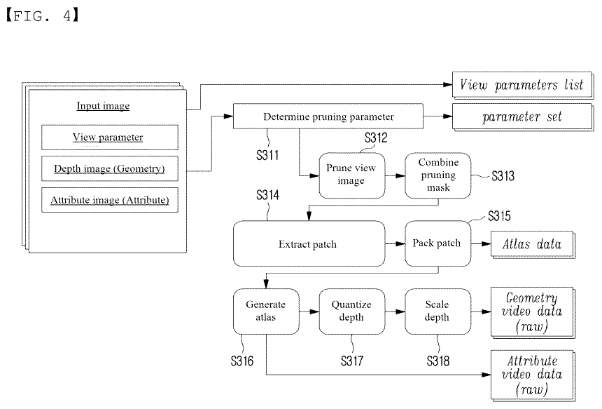

Subsequently, based on a pruning priority, an atlas may be generated and a generated atlas may be encoded S304. A process of encoding atlases is shown in detail in FIG. 4.

Specifically, a pruning parameter (e.g., a pruning priority, etc.) may be determined S311 and based on a determined pruning parameter, pruning may be performed for view images S312. As a result of pruning, a basic image with a highest priority is maintained as it is originally. On the other hand, through pruning for an additional image, overlapping data between an additional image and a reference image is removed. Through a warping process based on a depth image, overlapping data between an additional image and a reference image may be removed.

As a result of pruning, a pruning mask may be generated. If a pruning mask is generated, a pruning mask is combined in a unit of an intra-period S313. And, a patch may be extracted from a texture image and a depth image by using a combined pruning mask S314. Specifically, a combined pruning mask may be masked to texture images and depth images to extract a patch.

In this case, for an non-pruned view image (e.g., a basic image), a whole view image may be treated as one patch.

Subsequently, extracted patches may be packed S315 and an atlas may be generated S316. Specifically, a texture atlas and a depth atlas may be generated.

In addition, an immersive video processing device may determine a threshold value for determining whether a pixel is valid or invalid based on a depth atlas S317. In an example, a pixel that a value in an atlas is smaller than a threshold value may correspond to an invalid pixel and a pixel that a value is equal to or greater than a threshold value may correspond to a valid pixel. A threshold value may be determined in a unit of an image or may be determined in a unit of a patch.

For reducing the amount of data, a size of a depth atlas may be reduced by a specific ratio S318. When a size of a depth atlas is reduced, information on a reduction ratio of a depth atlas (e.g., a scaling factor) may be encoded. In an immersive video output device, a reduced depth atlas may be restored to its original size through a scaling factor and a size of a texture atlas.

Metadata generated in an atlas encoding process (e.g., a parameter set, a view parameter list or atlas data, etc.) and SEI (Supplemental Enhancement Information) are combined S305. In addition, a sub bitstream may be generated by encoding a texture atlas and a depth atlas respectively S306. And, a single bitstream may be generated by multiplexing encoded metadata and an encoded atlas S307.

An immersive video output device demultiplexes a bitstream received from an immersive video processing device S501. As a result, video data, i.e., atlas data and metadata may be extracted respectively S502 and S503.

An immersive video output device may restore an atlas based on parsed video data S504. In this case, when a depth atlas is reduced at a specific ratio, a depth atlas may be scaled to its original size by acquiring related information from metadata S505.

When a user's motion occurs, based on metadata, an atlas required to synthesize a viewport image according to a user's motion may be determined and patches included in the atlas may be extracted. A viewport image may be generated and rendered S506. In this case, in order to synthesize viewpoint image with the patches, size/position information of each patch and a camera parameter, etc. may be use.

As described above, all information of a viewpoint image designated as a basic view among the multi-viewpoint images may be encoded and transmitted to a decoder. On the other hand, information of a viewpoint image designated as an additional viewpoint among the multi-viewpoint images may be encoded/decoded by patching a region where rendering is impossible through a basic view and packing it into an atlas.

Each of an atlas for a texture component (i.e., a texture atlas) and an atlas for a depth component (i.e., a depth atlas) may be encoded/decoded. Meanwhile, in addition to an atlas, an entity map may be additionally defined. An entity map may be used for the purpose of distinguishing an object in a viewpoint image.

FIG. 6A, FIG. 6B, and FIG. 6C illustrate an entity map.

Each of FIG. 6A and FIG. 6B represents an image of a texture component and an image of a depth component. FIG. 6C represents an entity map in which each entity in an image is separately indicated.

A different identifier may be allocated to each entity. In this case, information identifying an entity corresponding to a corresponding patch may be encoded/decoded in a unit of a patch.

Table 1 shows an example in which entity identification information is encoded/decoded in a unit of a patch.

TABLE 1

| | Descriptor |
|---|---|
| pdu_miv_extension(tileID, p) { | |
| if(asme_max_entity_id > 0) | |
| pdu_entity_id[tileID][p] | u(v) |
| if(asme_depth_occ_threshold_flag) | |
| pdu_depth_occ_threshold[tileID][p] | u(v) |
| if(asme_patch_texture_offset_enabled_flag) | |
| for(c = 0; c < 3; c++) { | |
| pdu_texture_offset[tileID][p][c] | u(v) |
| if(asme_inpaint_enabled_flag) | |
| pdu_inpaint_flag[tileID][p] | u(1) |

In Table 1, a syntax pdu_entity_id [tileID] [p] represents an identifier of an entity corresponding to a patch where an identifier belonging to a tile whose identifier is tileID is p.

Meanwhile, entity identification information illustrated in Table 1 has no meaning other than a purpose of distinguishing an object. In other words, based on entity identification information illustrated in Table 1, it is possible to recognize that patches with a different entity identifier are derived from different entities, and it does not include any other information.

However, if information other than entity identification information is added, entity-based encoding/decoding may be utilized more widely. To this end, the present disclosure discloses a method for granting an entity map an additional purpose other than a purpose of identifying entities and encoding/decoding it as additional information.

According to an embodiment of the present disclosure, an entity map may be divided into a region without a motion and a region with a motion. By allocating a different value to an entity included in a region without a motion and an entity included in a region with a motion, respectively, whether an entity is a static entity or a dynamic entity may be determined. As an example, an entity that a value allocated to an entity is 0 may be included in a region without a motion (i.e., a static entity), and an entity that a value allocated to an entity is 1 may be included in a region with a motion (i.e., a dynamic entity).

Alternatively, an entity map may be divided into a Lambertian region and a non-Lambertian region. By allocating a different value to an entity included in a Lambertian region and an entity included in a non-Lambertian region, respectively, whether a surface of an entity has a Lambertian characteristic or a non-Lambertian characteristic may be determined.

Alternatively, an entity map may be divided into a Computer Graphic (CG) region and an actual image region. A different value may be allocated to an entity included in a CG region and an entity included in an actual image region.

Alternatively, an entity map may be divided into a boundary region and a non-boundary region that are sensitive to rendering. A different value may be allocated to an entity included in a boundary region and an entity included in an actual image region.

Alternatively, an entity map may be divided into a plurality of groups according to a motion direction or a motion degree of an object. A different value may be allocated to each of a plurality of groups. Afterwards, a value allocated to a group to which an entity belongs may be set as a value allocated to an entity.

Alternatively, a section may be divided by depth plane, and a different value may be allocated by section. Alternatively, a three-dimensional volume space may be divided into multiple spaces and a different value may be allocated to each space. Afterwards, a value allocated to a space or a section to which an entity belongs may be set as a value allocated to an entity.

As above, an entity map may be divided into a plurality of regions according to at least one criterion and a value allocated to an entity may be set according to a region to which an entity belongs, confirming a type of an entity based on a value allocated to an entity.

However, in order to determine a value allocated to an entity based on a type of an entity as above, at least one of a type of a value allocated to an entity or the number of types regarding an entity must be predefined in an encoder and a decoder.

As an example, when information for identifying each entity and information for distinguishing whether an entity is a dynamic entity or a static entity are encoded/decoded for an entity, two types of entity information need to be defined. In addition, according to a value of information allocated to an entity, an attribute indicated by a corresponding value must be predefined. As an example, it must be predefined that when a value allocated to an entity is 0, it represents an entity included in a region without a motion and a value allocated to an entity is 1, it represents an entity included in a region with a motion.

When more information than two types of information described above is encoded/decoded for an entity, a more complex rule must be defined in advance. As an example, when information indicating whether an entity is included in a CG region or is included in an actual image region is added to an entity identifier, the number of cases to be considered increases by two times. For example, it must be predefined that when a value allocated to an entity is 0, it represents a CG region without a motion, when a value allocated to an entity is 1, it represents an actual image region without a motion, when a value allocated to an entity is 2, it represents a CG region with a motion and when a value allocated to an entity is 3, it represents an actual image region with a motion.

As described above, the number/length of information to be encoded/decoded may be adaptively determined according to the number and a type of entity types.

Accordingly, the present disclosure proposes a method for encoding/decoding information representing the number of entity types and lower entity information.

Table 2 shows an example in which information representing the number of entity types and lower entity information are encoded/decoded according to an embodiment of the present disclosure.

TABLE 2

| | Descriptor |
|---|---|
| asps_miv_extension( ) { | |
| ... | |
| asme_max_entity_id | ue(v) |
| ... | |
| asme_entity_type | u(v) |
| for(c = 0; c < count1(asme_entity_type); c++) { | |
| asme_sub_entity_type[c] | u(v) |
| } | |

In Table 2, a syntax asme_max_entity_id represents the maximum value of en entity identifier.

In addition, asme_entity_type, a syntax corresponding to the number information of an entity type, represents the number of entity types. As an example, regarding an entity, when three types such as whether it is a static/dynamic entity, whether it is included in a CG/actual image region, whether it is included in a foreground/a middle ground/a background, etc. are defined, a syntax asme_entity_type may be set as 3.

A syntax asme_sub_entity_type, which corresponds to lower entity information, indicates one of a plurality of entity type candidates. In other words, a syntax asme_sub_entity_type may represent a type of type that must be encoded/decoded. As an example, asme_sub_entity_type may indicate at least one of whether an entity is a dynamic/static entity, whether an entity is included in a Lambertian region and a non-Lambertian region, a type of an image to which an entity belongs, whether an entity is included in a CG/actual image region, whether an entity is included in foreground/middle-ground/background regions, whether an entity is included in a boundary region/a non-boundary region, or a section to which an entity belongs.

A syntax asme_sub_entity_type may be encoded/decoded as many as the number of types indicated by a syntax asme_entity_type.

When an entity type to be encoded/decoded is determined, information corresponding to a determined type may be additionally encoded/decoded for each entity. As an example, information representing a value of a type corresponding to asme_sub_entity_type for each entity (i.e., entity type value information) may be encoded/decoded.

In Table 2, it was illustrated that a syntax asme_entity_type, which represents the number of entity types, and a syntax asme_sub_entity_type, which represents a type of an entity type, are encoded/decoded, respectively.

Unlike an example in Table 2, after predefining entity type information in which each bit indicates whether to activate an entity type (i.e., whether to encode/decode), entity type information may be used to define the number and a type of entity types to be encoded/decoded. Meanwhile, an encoder and a decoder may need to make a prior promise on a type represented by each bit configuring entity type information.

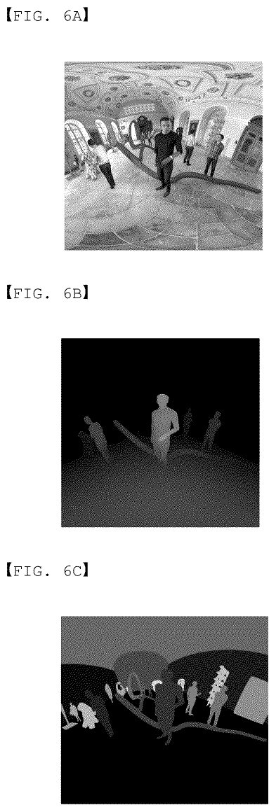

FIG. 7 represents the definition of each bit that configures entity type information.

As in an example of FIG. 7, an entity type of information represented by each bit in a unit of a bit may be predefined.

A value of 1 may be allocated to a bit corresponding to a type to be activated among the bits configuring entity type information, while a value of 0 may be allocated to a bit corresponding to a type to be deactivated.

In FIG. 7, it was illustrated that for foreground/middle-ground/background, CG/actual and static/dynamic division, a value of entity type information entity_type is set as 11.

A type of an entity type and/or a position of a bit corresponding thereto may be set differently from an example illustrated in FIG. 7.

The number of entity types may be determined by using a count1 function for entity type information. (i.e., count1 (entity_type)) Here, a count1 function may count the number of 1 in a binarized value. As an example, when a value of entity type information entity_type is 11, the number of types may be determined to be 3 through a count1 function. (count1 (11)=3)

Meanwhile, for each entity, instead of additionally encoding/decoding type value information, information about an entity type may be embedded in an entity identifier and encoded/decoded. In other words, an entity identifier may be additionally utilized for the purpose of distinguishing a type of an entity other than the purpose of identifying each entity.

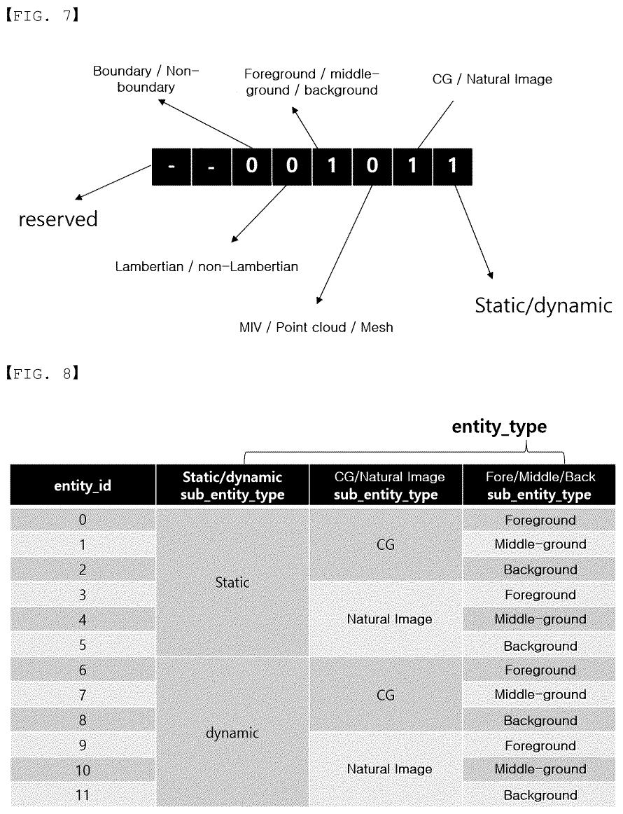

FIG. 8 represents an example in which a value of entity_id, an identifier allocated to an entity, is determined according to an entity type.

As an example, in an example of FIG. 8, entities whose entity identifier entity_id is 0 to 5 may be a static entity and entities whose entity identifier entity_id is 6 to 11 may be a dynamic entity. In addition, entities whose entity identifier entity_id is 0 to 2 or 6 to 8 may belong to a CG region and entities whose entity identifier entity_id is 3 to 5 or 9 to 11 may belong to an actual image region.

If a rule for determining a value of an entity identifier is defined in advance in an encoder and a decoder, not only division between entities, but also a type of a corresponding entity may be determined by entity_id, an identifier allocated to an entity.

As an example, when division between a CG region and an actual image region is required, entities that an entity identifier entity_id is 0, 1, 2, 6, 7 and 8 may be gathered to form a CG region and entities that an entity identifier entity_id is 3, 4, 5, 9 and 10 may be gathered to form an actual image region.

In the same way, entities that an entity identifier entity_id is 0, 3, 6 and 9 may be gathered to form a foreground region.

When an entity identifier is defined to represent an entity type, encoding/decoding of entity type value information may be omitted.

Meanwhile, when entity types to be activated are defined by using entity type information, information on asme_sub_entity_type, a syntax representing an entity type, or asme_entity_type, a syntax representing the number of entity types, may not be defined separately.

Meanwhile, when entity type information is embedded in an entity identifier and encoded/decoded, the maximum value of an entity identifier may be determined according to the number of types. Accordingly, in an example of Table 2, encoding/decoding of asme_max_entity_id, information representing the maximum value of an entity identifier, may be omitted.

However, when entity type information is embedded in an entity identifier, an entity identifier with a value greater than the number of entities may be used. Accordingly, a rule for generating an entity identifier in an encoder and a decoder must be defined in advance. After determining the number of entity types based on entity type information, a decoder may use a predefined rule to determine a type of an entity based on an entity identifier allocated to an entity.

Meanwhile, an entity map must be provided with a sequence or must be defined separately through pre-processing. In addition, an entity map needs to be defined separately according to an entity type. As an example, as in an example of FIG. 8, when three types are indicated through an entity identifier, three entity maps need to be defined. As an example, a first entity map for distinguishing between a static region and a dynamic region, a second entity map for distinguishing between a CG region and an actual image region and a third entity map for distinguishing between a foreground region, a middle-ground region and a background region may be defined, respectively.

In other words, it is needed to generate as many entity maps as the number of entity types.

Meanwhile, an entity map may be encoded together with an atlas and signaled to a decoder. In other words, a decoder may decode an entity map and render an image based on a decoded entity map.

In order to utilize entity information proposed in the present disclosure, the efficiency analysis of a patch unit may be required. Specifically, based on a ratio between a region occupied by patches in an atlas and a size of a patch that is lost without being packed into an atlas, how effectively an atlas is utilized may be determined.

To this end, first, as in Equation 1 below, a ratio of a region occupied by patches in an atlas may be calculated.

$$ratio of region occuipied by patehs within atlas = \frac{region occupied by patch}{eitire size of atlas} \times 100 \qquad [ Equation 1 ]$$

Meanwhile, in calculating a ratio of a region occupied by patches in an atlas, not only a valid region of a patch, but also an invalid region may be included.

A patch loss rate may be derived as in Equation 2 below.

$$Patch loss rate = \frac{\begin{matrix}Total number of pxiels of patches - \\ Number of pixels pacekd in an atlas\end{matrix}}{Total number of pxiels of patches} \times 100 \qquad [ Equation 2 ]$$

In Equation 2, the number of pixels may be calculated based on pixels configuring a valid region within a patch. The total number of pixels of patches may be calculated by including not only patches packed into an atlas, but also patches not packed into an atlas, and the number of pixels for patches packed into an atlas may be calculated based on only patches packed into an atlas among all patches.

Si an atlas is not large enough to pack all patches, patch loss may occur. In other words, when a ratio of a region occupied by patches within an atlas approaches 100%, there is not enough space to pack a patch, so a patch loss rate may increase.

In addition, patch loss may occur because a patch is not large enough to be packed into an atlas. In other words, even when a ratio of a region occupied by patches within an atlas does not approach 100%, patch loss may occur.

Meanwhile, when a patch loss rate is higher than a threshold value, an encoder may repack patches. In repacking patches, a size of patches may be adjusted. In this case, whether to increase or decrease a size of patches may be determined based on a ratio of a region occupied by patches within an atlas.

As an example, if a ratio of a region occupied by patches within an atlas is greater than or equal to a first threshold value, a size of at least one patch may be reduced and then repacking may be performed. On the other hand, if a ratio of a region occupied by patches within an atlas is smaller than a second threshold value, a size of patches may be expanded and then repacking may be performed. Here, the first threshold value may be the same as the second threshold value.

Alternatively, the first threshold value and the second threshold value may be different from each other. Here, if a ratio of a region occupied by patches is between the first threshold value and the second threshold value, patches may be repacked without adjusting size of them.

Meanwhile, selecting a basic view among multiple view images may be based on the positions of the cameras. For example, among the multiple cameras used to capture multiple view images, the initial view image captures by a camera located at the center point and looking at the front may be selected as the basic view. In addition, based on the positional difference value between the camera used to capture the initial view image and other cameras, a camera at an appropriate position may be selected, and a view image obtained from the selected camera may also be additionally selected as the basic view.

However, when selecting a basic view by considering only the spatial position of the cameras, there may occur a problem that a view image that does not include enough information on a main entity, that is, a view image that contains only few data on valid pixels related to the main entity, may be selected as the basic view.

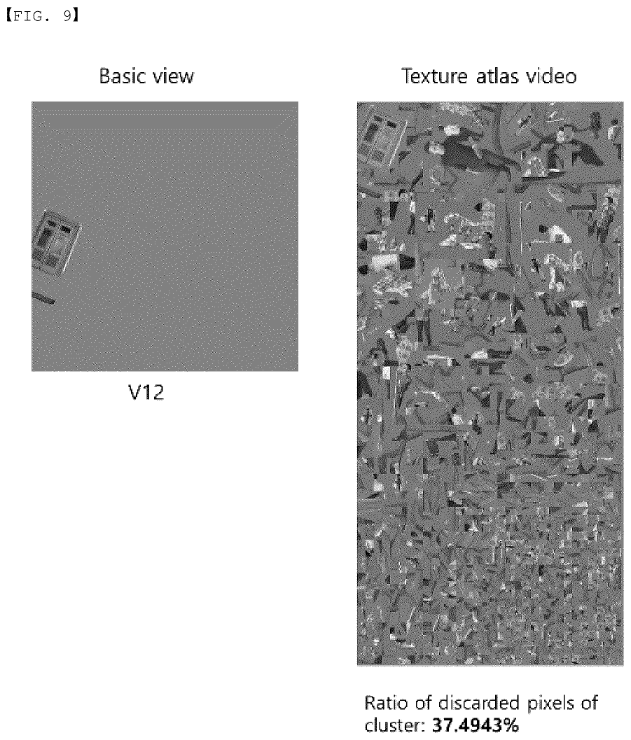

FIG. 9 is a drawing illustrating a problem related to selecting a basic view.

As in the example illustrated in FIG. 9, when selecting a basic view based on the position of the camera, a view image (V12 in FIG. 9) that contains less valid data (i.e., valid pixels) on a main entity may be selected as the basic view. Since the basic view does not contain sufficient valid data for the main entity, the amount of patches generated during the atlas generation process increases, which causes deterioration of the quality of encoding/decoding the atlas.

Accordingly, the present disclosure proposes an improved method for selecting a basic view. Specifically, according to the present disclosure, a basic view may be selected based on at least one of the ratio/number of valid pixels for the main entity in the view image or the number of main entities included in the view image.

Here, the main entity may be determined by the entity type. For example, whether the entity is a main entity may be determined based on at least one of whether the entity is a foreground, whether it is dynamic, or whether it is CG.

For convenience of explanation, it is assumed that a dynamic entity is a main entity.

The basic view may be determined based on the ratio occupied by the main entity in the view image, i.e., the number of pixels occupied by the main entity. That is, among the view images, the view image that includes the most pixels for the main entity may be selected as the basic view.

In the case where there are multiple main entities, the basic view may be determined by adding the number of pixels of each of the multiple main entities.

Alternatively, the basic view may be determined based on the number of main entities included in the view image. That is, the view image that includes the largest number of main entities among the view images may be selected as the basic view.

In the case where the number of main entities included in the view images is the same, the basic view may be determined based on the number of pixels occupied by the main entity in the view image.

Meanwhile, in determining the number of pixels occupied by the main entity or the number of main entities, the entire area of the view image may be considered. That is, the number of pixels occupied by the main entity or the number of main entities may be determined for the entire area of the view image. Alternatively, at least a portion of the view image may be set as the target area, and the number of pixels occupied by the main entity or the number of main entities may be determined only considering the target area. For example, the target image may be set on the central position of the view image. And the basic view may be selected based on the number of pixels occupied by the main entity or the number of main entities in the target area.

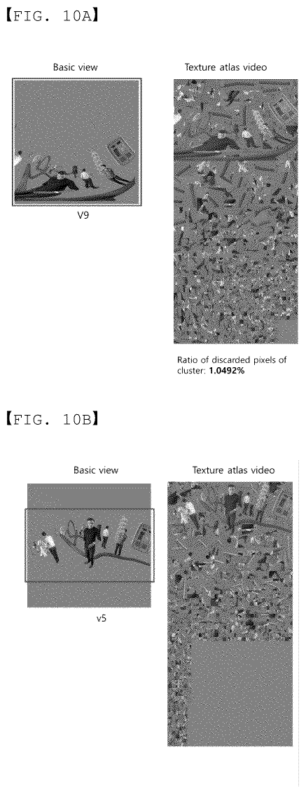

FIG. 10A and FIG. 10B illustrate an example of an area in which main entities are considered.

FIG. 10A illustrates an example of selecting a basic view based on the number of pixels occupied by the main entity based on the entire area of the view image. In this case, the view image v9 is selected as the basic view.

FIG. 10B illustrates an example of selecting a basic view based on the number of pixels occupied by the main entity based on the target area centered on the central position of the view image. In this case, unlike the example illustrated in FIG. 10A, the view image v5 is selected as the basic view. In FIG. 10B, an area that has a size of 50% of the view image, has the same width as the view image, and includes the center position of the view image is exemplified as the target area. However, the size/shape of the target area is not limited to the illustrated example.

As above, by selecting the view image with the most information about the main entity as the base view, the redundant data removed through pruning can be maximized.

A name of syntax elements introduced in the above-described embodiments is only temporarily given to describe embodiments according to the present disclosure. Syntax elements may be named with a name different from that proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors.

In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. An image encoding method, the method comprising:
generating an atlas based on a plurality of viewpoint images;
encoding the atlas; and
encoding metadata for the atlas,
wherein the metadata includes data of a patch packed in the atlas,
wherein the patch data includes type information of an entity corresponding to a patch.

2. The method of claim 1, wherein:
the metadata further includes type number information showing a number of encoded types,
lower entity information is further encoded as much as the number of the types.

3. The method of claim 2, wherein:
the lower entity information indicates one of a plurality of entity type candidates,
the type information represents a value allocated to the entity for an entity type indicated by the lower entity information.

4. The method of claim 1, wherein:
the metadata further includes entity type information,
the entity type information indicates a number and a type of entity types to be encoded.

5. The method of claim 4, wherein:
each of bits configuring the entity type information indicates whether information related to a corresponding entity type candidate should be encoded.

6. The method of claim 4, wherein:
when a value of a bit configuring the entity type information is 1, it represents that information related to a corresponding entity type candidate is encoded,
when the value of the bit configuring the entity type information is 0, it represents that the information related to the corresponding entity type candidate is not encoded.

7. The method of claim 1, wherein:
the type information is encoded by being embedded in identification information of the entity.

8. The method of claim 1, wherein:
the type information is encoded separately from identification information of the entity.

9. The method of claim 1, wherein:
the method further includes encoding an entity map,
the entity map is generated and encoded as many as a number of encoded types.

10. The method of claim 1, wherein:
the type information indicates at least one of whether a region where the entity is included is a static region or a dynamic region, whether it is a Computer Graphics (CG) region or an actual image region or whether it is a foreground or a background.

11. The method of claim 1, wherein generating the atlas comprises:
packing patches into the atlas; and
determining, based on a patch loss rate indicating a degree to which the patches are packed into the atlas, whether to repack the atlas.

12. The method of claim 11, wherein when the patch loss rate is greater than a first threshold value, the patches are repack to the atlas.

13. The method of claim 11, wherein, based on a ratio between the atlas and an area occupied by the patches, it is determined whether to adjust a size of the patches to repack the patches into the atlas.

14. The method of claim 13, wherein when the ratio is greater than or equal to a second threshold value, repacking is performed with reducing a size of at least one patch, and
wherein when the ratio is less than a third threshold value, repacking is performed with increasing a size of at least one patch.

15. An image decoding method, the method comprising:
decoding an atlas;
decoding metadata for the atlas; and
synthesizing an image for a target viewpoint by using the decoded atlas and the decoded metadata,
wherein the metadata includes data of a patch packed in the atlas,
wherein the patch data includes type information of an entity corresponding to a patch.

16. The method of claim 15, wherein:
the metadata further includes type number information showing a number of decoded types,
lower entity information is further decoded as much as the number of the types.

17. The method of claim 16, wherein:
the lower entity information indicates one of a plurality of entity type candidates,
the type information represents a value allocated to the entity for an entity type indicated by the lower entity information.

18. The method of claim 15, wherein:
the metadata further includes entity type information,
the entity type information indicates a number and a type of entity types to be decoded.

19. The method of claim 18, wherein:
each of bits configuring the entity type information indicates whether information related to a corresponding entity type candidate should be decoded.

20. A computer recordable storing medium recording an image encoding method, the computer recordable storing medium comprising:
generating an atlas based on a plurality of viewpoint images;
encoding the atlas; and
encoding metadata for the atlas,
wherein the metadata includes data of a patch packed in the atlas,
wherein the patch data includes type information of an entity corresponding to a patch.

21. An image encoding method, the method comprising:
selecting a basic view among a plurality of view images;
performing a pruning on a view image based on the basic view;
generating an atlas based on a result of the pruning; and
encoding the atlas,
wherein a selection of the basic view is based on a number of pixels of a main entity in each of the plurality of view images.
